(19) United States
(12) Patent Application Publication
(10) Pub. No.: US 2003/0058591 A1
(43) Pub. Date: Mar. 27, 2003

(54) Electro-static discharge protection for high frequency port on an integrated circuit

(76) Inventor: Jeffrey Johnson, Citrus Heights, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/965,253

(22) Filed: Sep. 26, 2001

(51) Int. Cl. H02H 9/00

(52) U.S. Cl. 361/56

(57) ABSTRACT

An inductor having an impedance is connected in series between an output of a high frequency circuit operating at a frequency and an electrostatic discharge (ESD) circuit. The ESD circuit is configured to protect the high frequency circuit from an ESD event. The impedance has a substantially high value at the frequency and a substantially low value at the ESD event.

### BACKGROUND

1. Field of the Invention

This invention relates to electro-static discharge (ESD). In particular, the invention relates to ESD protection.

2. Description of Related Art

Electro-static discharge (ESD) is a problem in integrated circuit (IC) technology. Typically, a Human Body Model (HBM) ESD event may be defined as an event where a current spike occurs that reaches approximately 90% of its maximum value in less than 10 nanoseconds (ns) and reduces to approximately 36% of its maximum value in less than 150 ns. An ESD event, if not properly handled, may destroy the internal circuitry of the integrated circuit where it occurs.

Several ESD circuits have been designed to protect an IC from failure due to an ESD event. One circuit, known as a gate grounded N-channel Metal Oxide Semiconductor (GGNMOS) has an NMOS transistor with the gate being grounded at the output pin of the circuit. With the gate being grounded, the NMOS transistor behaves like a diode. Although this circuit is responsive to an ESD event, it increases the capacitive loading at the output and therefore degrades performance at high frequencies. Another type of circuit uses several transistors connected in series at the output pin at the circuit and connected to the gate of the driving transistor. This type of circuit, however, is slow in responding to an ESD event and can only provide a limited amount of protection.

Therefore, there is a need to have an efficient technique to provide ESD protection at high frequencies.

### BRIEF DESCRIPTION OF THE DRAWINGS

The features and advantages of the present invention will become apparent from the following detailed description of the present invention in which:

FIG. 1 is a diagram illustrating a circuit package in which one embodiment of the invention can be practiced.

FIG. 2A is a diagram illustrating the circuit operating at normal high frequency mode.

FIG. 2B is a diagram illustrating the circuit operating at ESD event mode.

FIG. 3 is a flowchart illustrating a process to incorporate the inductor shown in FIG. 1 in a package of the IC according to one embodiment of the invention.

### DESCRIPTION

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention.

It is noted that the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

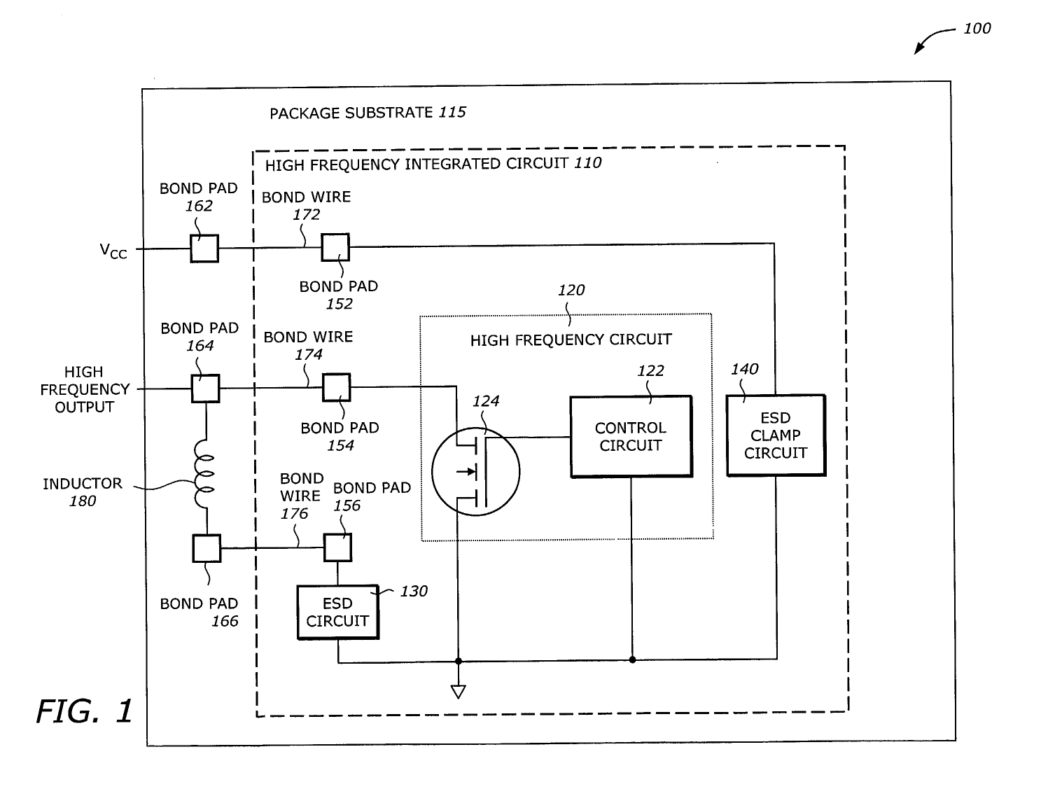

FIG. 1 is a diagram illustrating a circuit package or a circuit 100 in which one embodiment of the invention can be practiced. The circuit package 100 includes a high frequency integrated circuit 110 and a package substrate 115. The high frequency integrated circuit 110 includes a high frequency circuit 120, an ESD circuit 130, an ESD clamp circuit 140, bond pads 152, 154 and 156; and bond wires 172, 174 and 176. The package substrate 115 includes bond pads 162, 164 and 166, and an inductor 180.

The high frequency circuit 120 is a circuit operating at a high frequency. Typical operating frequency ranges at a gigahertz (GHz) level between 1 GHz to many GHz (e.g., 2.4 GHz). The high frequency circuit 120 includes a control circuit 122 and a drive circuit 124. The control circuit 122 generates a control signal to the drive circuit 124. The control circuit 122 may be a radio frequency (RF) circuit, a single-ended RF amplifier, a differential RF amplifier, or any digital or analog circuit that operates in this high frequency range.

The drive circuit 124 provides the driving output for the high frequency circuit 120. The drive circuit 124 is typically a transistor with a terminal connected to ground and an output terminal connected to provide a high frequency output.

The ESD circuit 130 is a circuit configured to provide ESD protection for the control circuit 122 and the drive circuit 124. The ESD circuit 130 may be a gate grounded NMOS transistor, a diode circuit, or any ESD protection circuit implemented through use of zener diodes, n-well resistors, polysilicon resistors, diffusion resistors, thin oxide field effect transistors (FETs), thick oxide FETs, low voltage trigger silicon controlled rectifiers (LVTSCRs), or a combination of any of these devices. The ESD circuit 130 may also be connected to the supply voltage instead of ground to respond to a possible ESD event.

The ESD clamp circuit 140 is connected between the power supply Vcc and the ground to clamp the voltage at a predetermined level to provide protection from a voltage surge or a high current spike when an ESD event occurs. An HBM ESD event may be defined as an event where a current spike occurs that reaches approximately 90% of its maximum value in less than 10 nanoseconds (ns) and reduces to approximately 36% of its maximum value in less than 150 ns. An ESD event may be negative or positive and the ESD circuit 130 is designed accordingly.

The control circuit 122, the drive circuit 124, the ESD circuit 130 and the ESD clamp circuit 140 are typically fabricated or manufactured to be on the same silicon die. During packaging, the silicon die is mounted on the package substrate. The package may be a ball grid array (BGA) or a flip-chip package. As is known by one skilled in the art, other packaging methods can be used. The bond pads 152, 154 and 156 are provided in the integrated circuit 110. The bond pad 152 provides connection terminal for one end the ESD clamp circuit 140 to the power supply Vcc. The other end of the ESD clamp circuit 140 is typically connected to ground. The bond pad 154 provides connection terminal to the output pin of the IC, or the output of the high frequency circuit 120. The bond pad 156 provides connection terminal to one end of the ESD circuit 130. The other end of the ESD circuit 130 is typically connected to ground. The bond pad 162 provides connection terminal directly to the power supply. A bond wire 172 is connected between the two bond pads 152 and 162. The bond pad 164 provides connection terminal for the high frequency output pin. The bond pad 164 is also used to connect to one end of the inductor 180. The bond pad 166 provides connection terminal for the other end of the inductor 180. The bond pads 154 and 164 are connected via a bond wire 174. The bond pads 156 and 166 are connected via a bond wire 176.

The inductor 180 is connected in series or in line between the output of the high-frequency circuit 120 and the non-ground terminal of the ESD circuit 130 via bond wires 174 and 176. The inductor 180 may be fabricated using any PCB fabrication process. The inductor 180 has an inductance selected such that its impedance has a substantially high value at the operating frequency of the high frequency circuit and a substantially low value when the ESD event occurs.

Let Z, f, and L be the impedance (in Ohms, or Ω) of the inductor 180, the operating frequency of the high frequency circuit 120 (in Hertz), and the inductance of the inductor 180 (in Henry), respectively. The relationship among these values is given by the following equation:

Z=2*π*f*L (1)

The inductance of the inductor 180 is selected such that at high frequencies, the inductor behaves like an open circuit and at the ESD event, or at low frequencies, it behaves like a short circuit. As an illustration, suppose L=50 nanoHenry (nH). Then,

f=2.4 GHz=2.4×10⁹ Hz→Z≅750Ω (2)

f=25 MHz=25×10⁶ Hz→Z≅7Ω (3)

Table 1 below shows some values of the impedance for various values of the inductance and the frequency.

TABLE 1

| L(nH) | F | Z(Ω) | | |
|---|---|---|---|---|
| 50 | 10 MHz | 3 | | |
| | | | {close oversize brace} | Low frequency |
| | 25 MHz | 8 | | |
| | 1 GHz | 300 | | |
| | 2.4 GHz | 750 | {close oversize brace} | High frequency |
| | 5 GHz | 1500 | | |
| 100 | 10 MHz | 6 | | |
| | | | {close oversize brace} | Low frequency |
| | 25 MHz | 16 | | |
| | 1 GHZ | 600 | | |
| | 2.4 GHz | 1500 | {close oversize brace} | High frequency |
| | 5 GHz | 3100 | | |

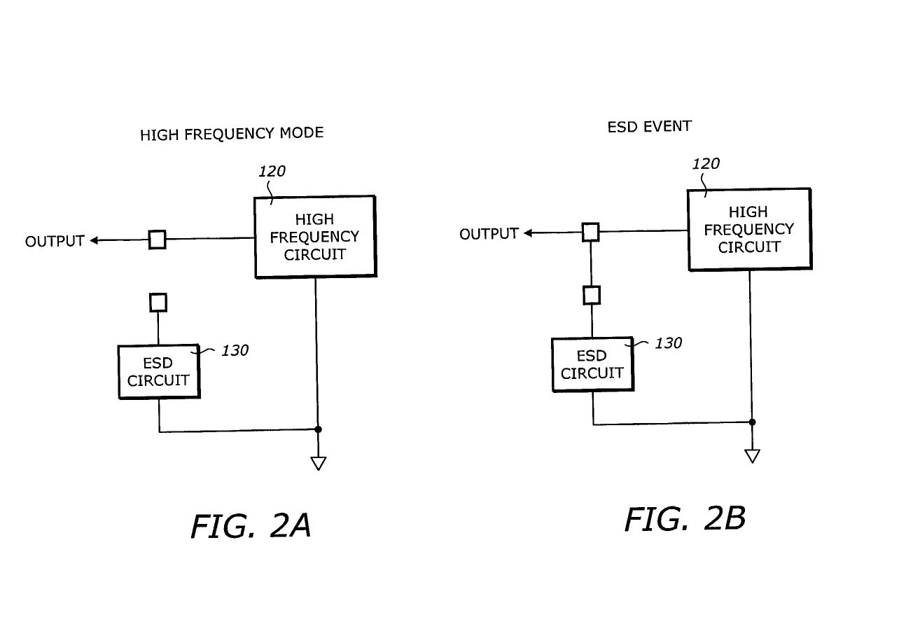

FIG. 2A is a diagram illustrating the circuit operating at normal high frequency mode. In this mode, the high frequency circuit 120 operates normally at its operating frequency. The operating frequency may range from 1 GHz to many GHz. During normal mode, the ESD circuit 130 is not needed. Separating the ESD circuit 130 from the high frequency circuit 120 may be also beneficial in that the alternating current (AC) response of the high frequency circuit 120 may be enhanced or improved. As calculated above, at high frequencies, the impedance of the inductor 180 is approximately several hundred Ω. In addition, capacitive loading may also increase this impedance value even higher. This value is high enough so that the inductor 180 may behave like an open circuit, isolating the ESD circuit 130 from the high frequency output. This impedance is coupled in parallel with the load resistor at the output of the high frequency circuit 120. This load resistor may be approximately equal to 50 Ω. The equivalent resistance is therefore approximately 47 Ω which is not far off the 50 Ω value. The resulting output impedance may attenuate the frequency response of the high frequency circuit 120 slightly, typically only a few percent. This slight attenuation does not reduce the circuit performance much, and therefore is acceptable when the high frequency circuit 120 operates at its normal operating frequency.

FIG. 2B is a diagram illustrating the circuit operating at the ESD event mode. In this mode, an ESD event occurs. When this event occurs, the frequency of the current through the inductor 180 becomes low. At low frequencies, or when the an ESD event occurs, the impedance of the inductor 180 is reduced to approximately less than 10 Ω. This value is low enough so that the inductor 180 behaves like a short circuit connecting the ESD circuit 130 to the high frequency output. In this way, the ESD circuit 130 may function or operate as a regular ESD circuit to protect the high-frequency circuit and the circuit package 100 from failure due to an ESD event.

For most practical purposes, the inductance of the inductor 180 may be selected to be approximately between 50 nH to 100 nH. With this small value of inductance, the inductor 180 can be fabricated using standard Printed Circuit Board (PCB) technology to be part of the device in the package. The inductor 180 as such fabricated may occupy an area having dimensions of approximately 2 mm×4 mm. For a differential amplifier circuit having two high frequency circuits, two inductors may be used, one for each circuit.

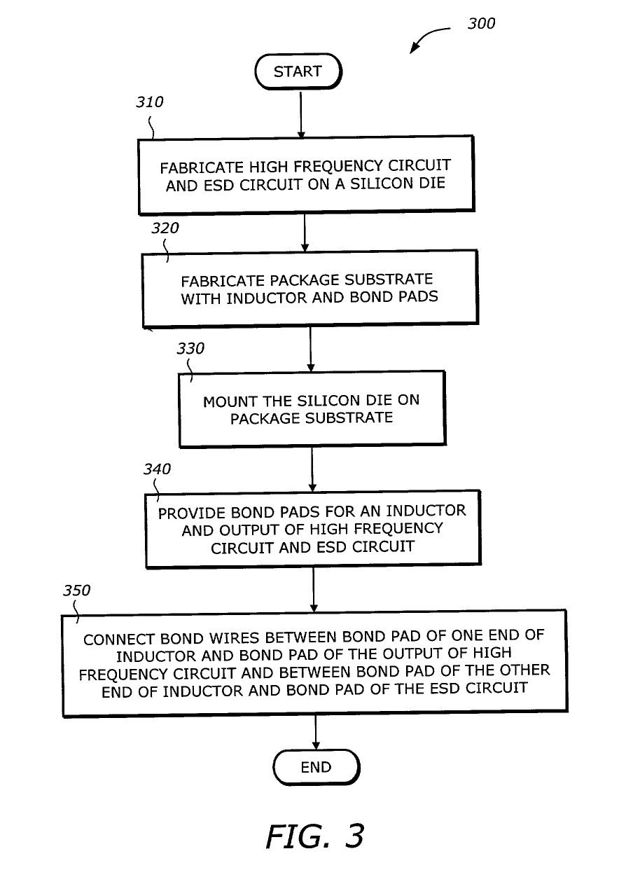

FIG. 3 is a flowchart illustrating a process 300 to incorporate the inductor shown in FIG. 1 in a package of the IC according to one embodiment of the invention.

Upon START, the process 300 fabricates the high frequency circuit and the ESD circuit on the same silicon die (Block 310). After silicon die fabrication, the package substrate is manufactured with the inductor between bond pads 164 and 166 (Block 320). Next, the silicon die is mounted on the package substrate (Block 330). The packaging technology may be the ball grid array (BGA) or the flip-chip package. Then, the process 300 provides bond pads for the inductor, output of the high frequency circuit, and the non-ground terminal for the ESD circuit (Block 340). Next, the process 300 connects a bond wire between the high frequency pad and one end of the inductor and a bond wire between the ESD circuit pad and the bond pad of the other end of the inductor (Block 350). Then, the process 300 is terminated.

The present invention therefore provides an efficient means to enhance the ESD protection offered by the ESD circuit 130 (FIG. 1) with negligible attenuation at the output. The ESD protection performance is improved by several times than with the ESD circuit used alone.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. An apparatus comprising:
an inductor having an impedance connected in series between an output of a high frequency circuit operating at a frequency and an electrostatic discharge (ESD) circuit configured to protect the high frequency circuit from an ESD event, the impedance having a substantially high value at that frequency and a substantially low value at the ESD event.

2. The apparatus of claim 1 wherein the ESD circuit has first and second terminals, the first terminal being connected to one end of the inductor, the second terminal being connected to ground.

3. The apparatus of claim 1 wherein the ESD circuit is a gate grounded metal oxide semiconductor (NMOS) transistor.

4. The apparatus of claim 1 wherein the ESD circuit is a diode circuit.

5. The apparatus of claim 1 wherein the inductor is connected between a first bond pad of the output and a second bond pad of the ESD circuit, the first and second bond pads being on a package substrate in a package encapsulating the high frequency circuit and the ESD circuit.

6. The apparatus of claim 5 wherein the inductor is connected between the first and second bond pads via first and second bond wires.

7. The apparatus of claim 5 wherein the high frequency and ESD circuits are on a silicon die mounted on the package substrate.

8. The apparatus of claim 5 wherein the package is one of a ball grid array (BGA) package and a flip-chip package.

9. The apparatus of claim 1 wherein the frequency is higher than 1 gigahertz.

10. The apparatus of claim 1 wherein the ESD event corresponds to a low frequency event.

11. A method comprising:
connecting an inductor in series between an output of the high frequency circuit operating at a frequency and an electrostatic discharge (ESD) circuit configured to protect the high frequency circuit from an ESD event, the inductor having an impedance with a substantially high value at the frequency and a substantially low value at the ESD event.

12. The method of claim 11 wherein connecting the inductor comprises:
connecting a first terminal of the ESD circuit to one end of the inductor, and connecting a second terminal of the ESD circuit to ground.

13. The method of claim 11 wherein the ESD circuit is a gate grounded metal oxide semiconductor (NMOS) transistor.

14. The method of claim 11 wherein the ESD circuit is a diode circuit.

15. The method of claim 11 wherein connecting the inductor comprises connecting the inductor between a first bond pad of the output and a second bond pad of the ESD circuit, the first and second bond pads being on a package substrate in a package encapsulating the high frequency circuit and the ESD circuit.

16. The method of claim 15 wherein connecting the inductor comprises connecting one end of the inductor to the first bond pad via a first bond wire; and connecting an other end of the inductor to the second bond pad via a second bond wire.

17. The method of claim 15 wherein connecting the inductor comprises:
mounting a silicon die containing the high frequency and ESD circuits on the package substrate.

18. The method of claim 15 wherein the package is one of a ball grid array (BGA) package and a flip-chip package.

19. The method of claim 11 wherein the frequency is higher than 1 gigahertz.

20. The method of claim 11 wherein the ESD event corresponds to a low frequency event.

21. A circuit comprising:
a high frequency circuit operating at a frequency, the high frequency circuit having an output;
an electrostatic discharge (ESD) circuit configured to protect the high frequency circuit from an ESD event; and
an inductor having an impedance connected in series between the output of the high frequency circuit and the electrostatic discharge (ESD) circuit, the impedance having a substantially high value at the frequency and a substantially low value at the ESD event.

22. The circuit of claim 11 wherein the ESD circuit has first and second terminals, the first terminal being connected to one end of the inductor, the second terminal being connected to ground.

23. The circuit of claim 11 wherein the ESD circuit is a gate grounded metal oxide semiconductor (NMOS) transistor.

24. The circuit of claim 11 wherein the ESD circuit is a diode circuit.

25. The circuit of claim 11 wherein the inductor is connected between a first bond pad of the output and a second bond pad of the ESD circuit, the first and second bond pads being on a package substrate in a package encapsulating the high frequency circuit and the ESD circuit.

26. The circuit of claim 15 wherein the inductor is connected between the first and second bond pads via first and second bond wires.

27. The circuit of claim 15 wherein the high frequency and ESD circuits are on a silicon die mounted on the package substrate.

28. The circuit of claim 15 wherein the package is one of a ball grid array (BGA) package and a flip-chip package.

29. The circuit of claim 11 wherein the frequency is higher than 1 gigahertz.

30. The circuit of claim 11 wherein the ESD event corresponds to a low frequency event.
